(19) United States
(12) Patent Application Publication
(10) Pub. No.: US 2015/0074332 A1
(43) Pub. Date: Mar. 12, 2015

(54) MEMORY CONTROLLER AND MEMORY SYSTEM

(71) Applicant: Kabushiki Kaisha Toshiba, Minato-ku (JP)

(72) Inventors: Chihoko SHIGETA, Kunitachi-shi (JP); Yoshihisa KOJIMA, Kawasaki-shi (JP)

(73) Assignee: Kabushiki Kaisha Toshiba, Minato-ku (JP)

(21) Appl. No.: 14/196,590

(22) Filed: Mar. 4, 2014

Related U.S. Application Data
(60) Provisional application No. 61/876,015, filed on Sep. 10, 2013.

(51) Int. Cl. G06F 3/06

(52) U.S. Cl. CPC G06F 3/0659; G06F 3/0604; G06F 3/0679
USPC 711/103

(57) ABSTRACT

A memory controller that reads data from nonvolatile memory according to an embodiment of the present invention includes: first and second ports that receive commands; a thread executing unit that executes a first thread that is a set of processes based on the command received by the first port, and a second thread that is a set of processes based on the command received by the second port; a buffer; and a buffer managing unit that manages a first buffer area to be allotted to the first thread and a second buffer area to be allotted to the second thread, wherein the thread executing unit stores read data in the first buffer area upon executing the first thread, and stores read data in the second buffer area upon executing the second thread, and the buffer managing unit dynamically allots regions in the buffer to the first and second buffer areas.

### CROSS-REFERENCE TO RELATED APPLICATIONS

This application is based upon and claims the benefit of priority from Provisional Patent Application No. 61/876,015, filed on Sep. 10, 2013; the entire contents of which are incorporated herein by reference.

### FIELD

Embodiments of the present invention relate to a memory controller and a memory system.

### BACKGROUND

An SSD (Solid State Drive) is provided with a buffer area (buffer memory) for temporarily storing read-out data.

An SSD drive including a plurality of ports is capable of connecting to a plurality of hosts via the plurality of ports. In such a configuration, the plurality of hosts can cause the SSD drive to execute a read operation in parallel. The SSD drive handles processing of read commands received via the respective ports as threads that are sets of processing for each port. Accordingly, the SSD drive operates normally with a plurality of threads for the plurality of hosts.

Conventionally, in the case of operating in the plurality of threads, an allotted amount of the buffer area for each thread was a fixed amount. Accordingly, when the allotted amount of the buffer area is not ample, a size of the buffer area becomes insufficient in cases of processing commands with a large read-out size in one thread, and processing with a large number of read commands being issued simultaneously from the hosts.

### BRIEF DESCRIPTION OF THE DRAWINGS

FIG. 1 is a diagram illustrating a configuration of a memory system of embodiments of the invention.

FIG. 2 is a diagram for explaining allotment of resources to respective threads in the embodiments of the invention.

FIG. 3 is a flow chart illustrating a process of a read command of a first embodiment of the invention.

FIG. 4 is a diagram for explaining a surplus of the resources in the embodiments of the invention.

FIG. 5 is a flow chart illustrating a process of a read command of second and third embodiments of the invention.

FIG. 6 is a flow chart illustrating allotment of resources of the second embodiment of the invention.

FIG. 7 is a diagram illustrating a number of used resources of the second embodiment of the invention.

FIG. 8 is a diagram for explaining a command queue of the third embodiment of the invention.

FIG. 9 is a flow chart illustrating a process of a fourth embodiment of the invention.

FIG. 10 is a diagram for explaining page read of the fourth embodiment of the invention.

FIG. 11 is a diagram for explaining data transfer time of the fourth embodiment of the invention.

### DETAILED DESCRIPTION

A memory controller that reads data from nonvolatile memory according to an embodiment of the present invention includes: first and second ports that receive commands; a thread executing unit that executes a first thread that is a set of processes based on the command received by the first port, and a second thread that is a set of processes based on the command received by the second port; a buffer; and a buffer managing unit that manages a first buffer area to be allotted to the first thread and a second buffer area to be allotted to the second thread, wherein the thread executing unit stores read data in the first buffer area upon executing the first thread, and stores read data in the second buffer area upon executing the second thread, and the buffer managing unit dynamically allots regions in the buffer to the first and second buffer areas.

Hereinbelow, embodiments of a memory controller and a memory system will be described in detail with reference to the attached drawings. Note that these embodiments do not limit the present invention.

### First Embodiment

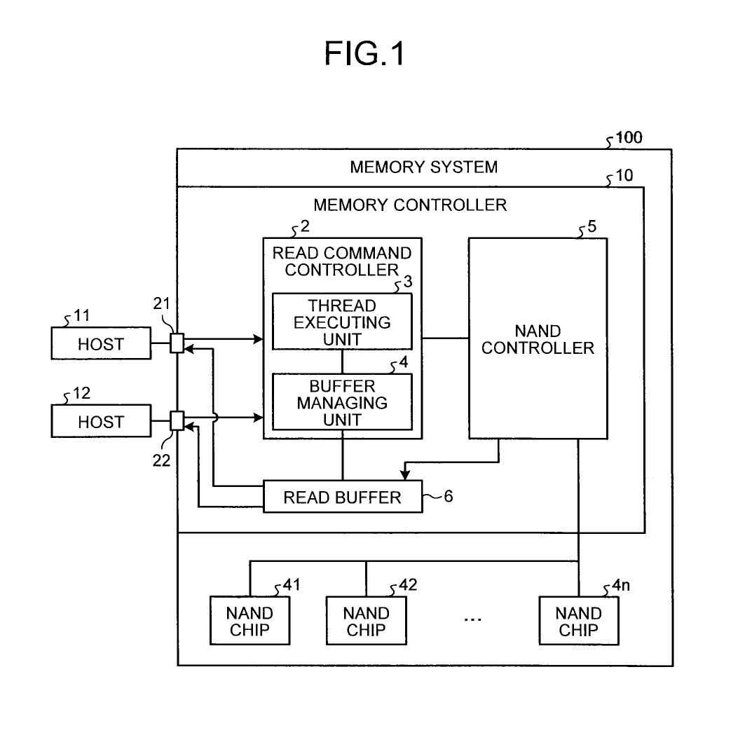

FIG. 1 is a diagram illustrating a configuration of a memory system 100 of an embodiment of the invention. The memory system 100 is for example an SSD drive. The memory system 100 includes a memory controller 10, and NAND chips 41, 42, . . . 4n that are nonvolatile memory. The memory controller 10 functions as a controller of a front end and a back end, including a host interface function. The memory controller 10 includes a read command controller 2, a NAND controller 5, a read buffer 6, and ports 21, 22 capable of connecting with external hosts. The read command controller 2 includes a thread executing unit 3 and a buffer managing unit 4. The read buffer 6 is for example SRAM. The ports may be two or more. Although it is possible to connect to different hosts by each port, it is possible to connect to one host via the two ports. Read-out data from the NAND chips 41, 42, . . . 4n are temporarily retained in the read buffer 6. The read buffer 6 is managed by the buffer managing unit 4. Functions of the read command controller 2 and the NAND controller 5 are realized for example by one or more processors. Notably, in the embodiment, although an example that uses NAND chips (NAND flash memory chips) as the nonvolatile memory will be described, no limitation is made hereto.

The memory system 100 of the embodiment handles a set of processes based on a command received from outside via the port 21 as a thread 0, and handles a set of processes based on a command received from outside via the port 22 as a thread 1. A thread is a set of processes based on a command inputted via a port.

The read buffer 6 of the memory system 100 of the embodiment includes regions worth sixty-four clusters. One cluster corresponds to eight sectors. In the read buffer 6, in assuming that a region for storing data worth one cluster is one resource, the read buffer 6 includes sixty four pieces of resources.

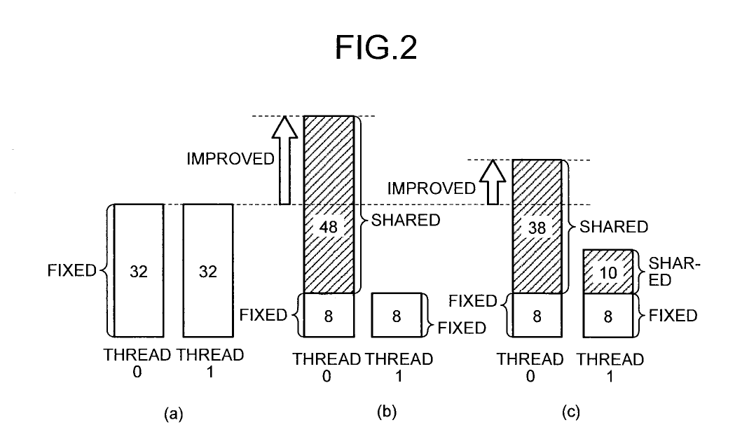

The regions of the read buffer 6 of the embodiment includes resources (fixed resources) allotted fixedly (statically) to each of the thread 0 and the thread 1, and resources (shared resources) shared by the thread 0 and the thread 1 and allotted dynamically and variably. For each thread, as illustrated in (b) in FIG. 2 for example, eight pieces of resources are allotted as the fixed resources. Since the resources other than the fixed resources become the shared resources, there are forty-eight pieces (=64-8*2) of shared resources.

The shared resources are allotted dynamically according to an amount of the resources that become necessary in each thread. In the embodiment, the resources that become necessary in the process based on the read command executed in the thread 0 are allotted from the shared resources. Similarly, the resources that become necessary in the process based on the read command executed in the thread 1 are allotted from the shared resources.

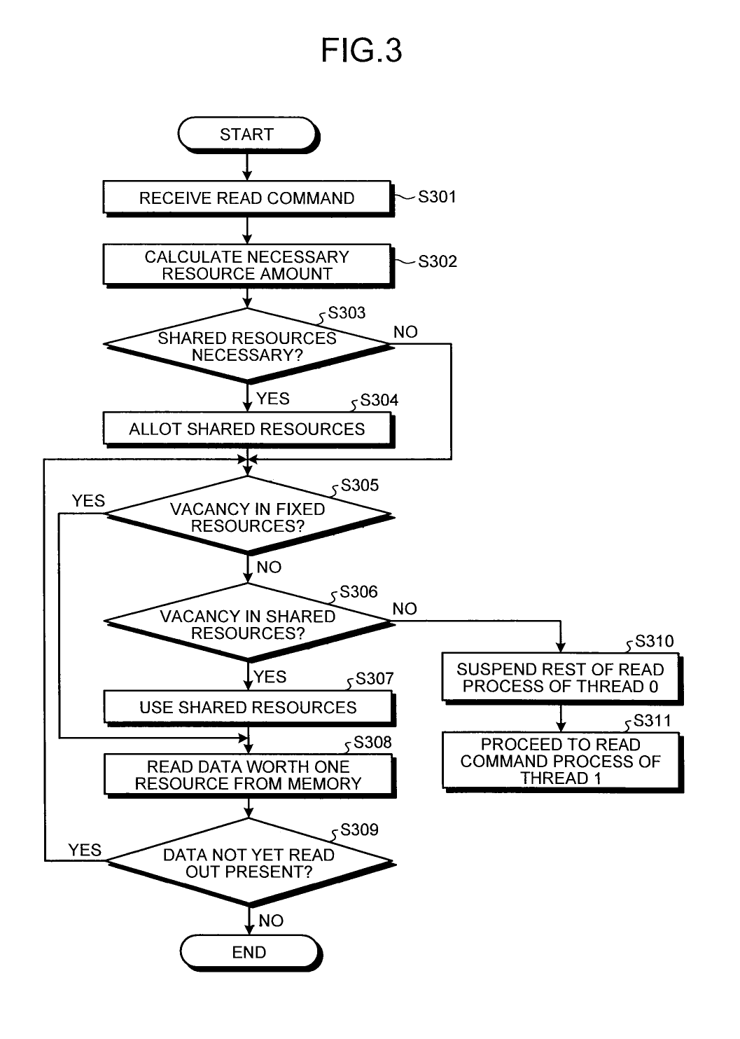

A read command process in the thread 0 will be described as an example, and an operation of the memory system 100 will be described by using a flow chart of FIG. 3.

Firstly, in step S301, the read command is received via the port 21. Accordingly, the process based on the read command is included in the thread 0. In step S302, an amount of resources that will be necessary for the process based on the read command is specified. For example, in assuming that a read-out size of the read command is 256 kbytes and a data size that can be stored in one resource is 4 kbytes, the resources necessary for the execution of the read command becomes sixty four pieces. Next, a determination is made as to whether allotment of the shared resources is necessary or not (step S303). In a case where the allotment of the shared resources is necessary since the read-out will not be completed by the eight pieces of fixed resources (step S303: Yes), the buffer managing unit 4 allots forty-eight pieces of shared resources to the thread 0 as illustrated in (b) of FIG. 2 in step S304. In this case, the necessary resources become fifty-six by subtracting the eight pieces of fixed resources from sixty four pieces, which is greater than the shared resource, so the buffer managing unit 4 allots all of the shared resources to the thread 0. That is, the shared resources are allotted for the necessary resource capacity exceeding the fixed resources.

The process proceeds to step S305 after step S304. Further, in a case where the read-out size of the read command is a size that can be read out by the fixed resources and thus the shared resources are not necessary (step S303: No), the process also proceeds to step S305. In step S305, a determination is made on whether there is a vacancy in the fixed resources of the thread 0. That is, a determination is made on whether there is a region in which data being read out does not exist or not in the regions of the fixed resources of the thread 0 in the read buffer 6.

In a state where the data read from the NAND chips 41, 42, . . . 4n to the read buffer 6 is not performed at all, since there is a vacancy in the fixed resources (step S305: Yes) due to all of the eight pieces of fixed resources of the thread 0 being vacant, the process proceeds to step S308. In step S308, the thread executing unit 3 performs one resource worth of data read from the NAND chips 41, 42, . . . 4n via the NAND controller 5. That is, the thread executing unit 3 causes one resource worth of the read-out data from the NAND chips 41, 42, . . . 4n to be read out in the region of the fixed resource in the read buffer 6.

Thereafter, the process proceeds to step S309, and a determination is made on whether there is data that has not yet been read out or not. For example, in a case of just having read out the first one resource worth, since only one resource worth among the sixty four resources worth that are now necessary has been read out, the process returns to step S305 for still having data that has not yet been read out (step S309: Yes). This is repeated until the vacancy worth the eight pieces of fixed resources is used up. When the reading of the data worth the eight pieces of fixed resources is completed, the vacancy in the fixed resources of the thread 0 becomes zero in step S305 (step S305: No). That is, the process proceeds to step S306 since there is no ninth fixed resource.

In step S306, a determination is made on whether there is a vacancy in the shared resources of the thread 0 or not. That is, a determination is made on whether there is a region in which data being read out does not exist among the regions of the shared resources in the read buffer 6 or not. Since the buffer managing unit 4 allotted the forty eight pieces of shared resources to the thread 0 in step S304, there is a vacancy in the shared resources (step S306: Yes); whereby the process proceeds to step S307 and uses one piece of the shared resources. That is, in step S308, one resource worth of data is read out to the region in the shared resource via the NAND controller 5 from the NAND chips 41, 42, . . . 4n in one resource worth size. Thereafter, the process proceeds to step S309, and a determination is made on whether there is data that has not yet been read out or not. The process ends in a case where there is no read-out data (step S309: No), however, returns to step S305 in a case where there still is read-out data left (step S309: Yes). This is repeated until the vacancy worth the forty eight pieces of shared resources is used up.

When the read out worth the forty eight pieces of shared resources is finished, the process proceeds to step S310 since there no longer is a vacancy in the shared resources (step S306: No), where the thread executing unit 3 suspends rest of the read out process of the thread 0. Thereafter, the process proceeds to the read command process of the thread 1 (step S311). In the read command process of the thread 1 also, the processes similar to the above processes are executed.

In a case where the fifty-six pieces of resources became insufficient for processing the read command for the thread 0 (step S306: No), the process of the thread 0 is suspended as aforementioned (step S310), and the process of the read command for the subsequent thread 1 is started (step S311). Similarly, in a case where the resources of the thread 1 became insufficient, or in a case where the process has been finished quickly for example for a size of the read-out data of the read command in the thread 1 being small or the like, the thread executing unit 3 restarts the process of the read command of which process was suspended in the thread 0. Accordingly, switching the process of the threads due to insufficient resources or units of the processes of the read commands is referred to as switching the threads by round robin.

Notably, the read-out data stored in the shared resources is thereafter transferred sequentially to the host, and the shared resource that had transferred the read-out data to the host is released. The releasing of the shared resources is an operation independent from the switching of the processes of the thread as aforementioned.

According to the memory system 100 of the present embodiment, it becomes possible to use up a total of fifty-six pieces of resources for one thread, namely the eight pieces of fixed resources and the forty eight pieces of shared resources. That is, compared to a method of fixedly allotting the sixty four pieces of resources to two threads by thirty two pieces each as illustrated in (a) of FIG. 2, according to the method of allotting resources of the present embodiment as in (b) of FIG. 2, twenty four pieces of resources worth of performance is improved for example in the thread 0. This, as in the example described above, applies similarly to improved performances, not only in cases where the read command controller 2 received the read command with the read-out size of 256 kbytes as the thread 0, but also in cases where sixty four pieces of read commands with the read-out size of 4 kbytes are received in the thread 0.

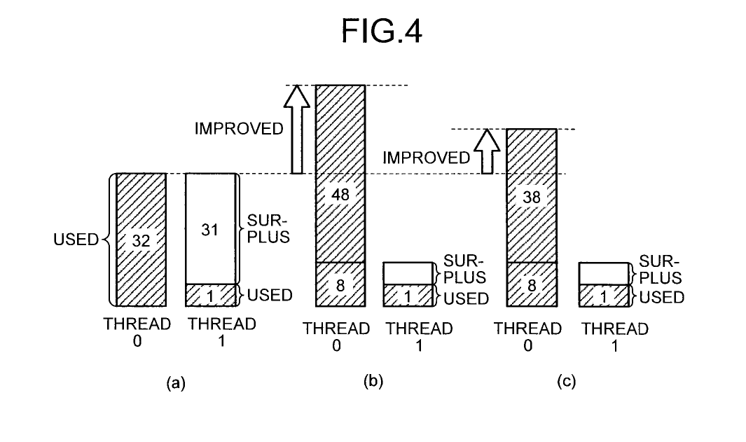

For example, in the case where the read command controller 2 received the read command that reads out 256 kbytes that is worth sixty four pieces of resources as the thread 0, and received the read command that reads out 4 kbytes that is worth one piece of resource as the thread 1, the surplus of the resources become as illustrated in FIG. 4.

In the method that fixedly allots the sixty four pieces of resources to two threads by thirty two pieces each as illustrated in (a) of FIG. 4, all of the thirty two pieces as allotted are used in thread 0, whereas in the thread 1, thirty one pieces of resources become excessive since only one piece of resource is used therein. Contrary to this, when the resources are allotted as illustrated in (b) of FIG. 4 as in this embodiment, the thread 0 can use fifty six pieces of resources can be used for the process of the read command of 256 kbytes, and the thread 1 uses one piece among the eight pieces as fixedly allotted thereto, and only seven pieces of resources become excessive. As above, according to the memory system 100 of the present embodiment, it becomes possible to reduce the surplus in the resources.

According to the first embodiment, the resources are allotted dynamically depending on a load of each thread in the memory system that works on a plurality of threads. Due to this, larger number of resources can be allotted to threads with the read command with a large amount of read-out data and with large number of simultaneous issuance of read commands from a host, whereby the performance of the read command process can be improved.

### Second Embodiment

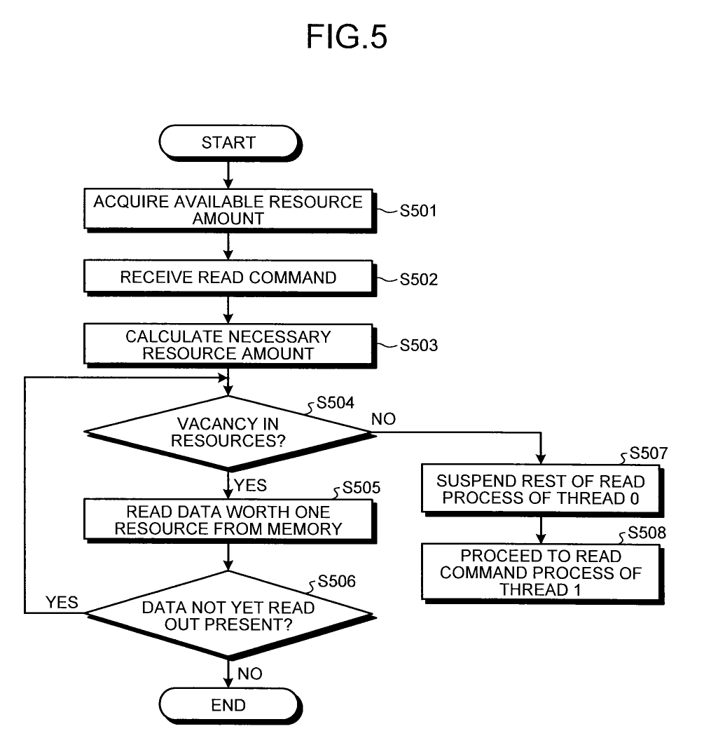

In the present embodiment also, regions of a read buffer 6 include fixed resources to be allotted to each of two threads, and shared resources that can be used in common in all threads. The shared resources are allotted dynamically to each thread by the following method. In the present embodiment, the shared resources are allotted dynamically based on a number of resources used in a read command that had been processed in each thread. An operation of the memory system 100 will be described using a flow chart of FIG. 5 with a process of a read command for a thread 0 as an example. In the present embodiment also, it is assumed that fixed resources in each thread are eight pieces, and shared resources therein are forty eight pieces.

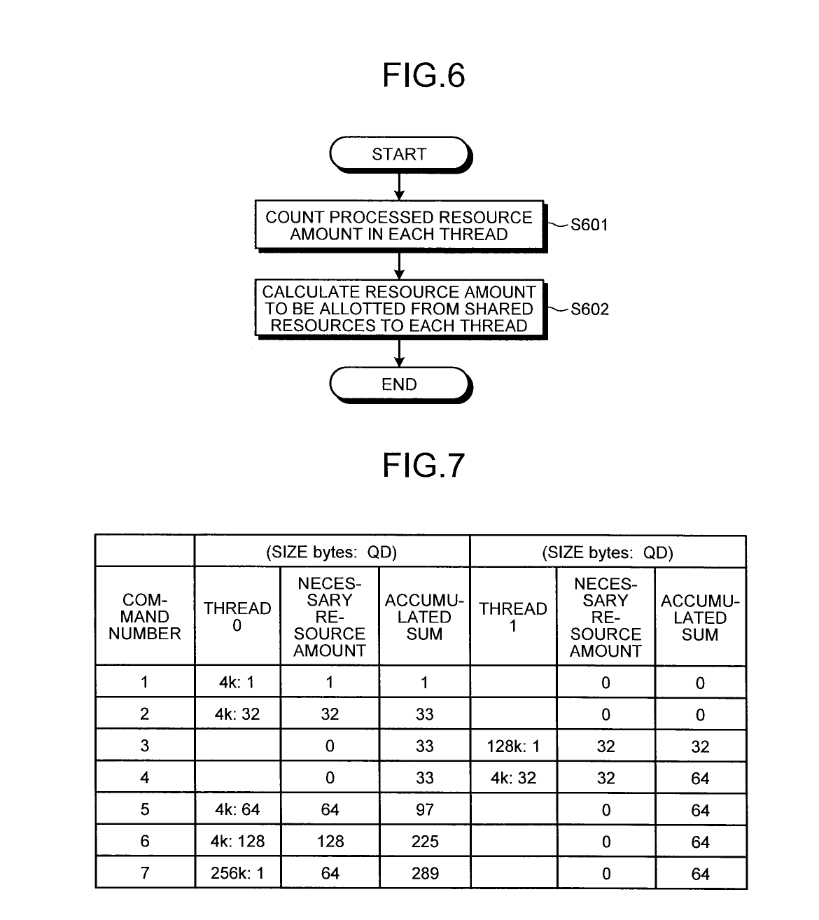

Firstly, an amount of resources that can be used in the thread 0 is acquired in step S501. Specifically, according to the flow chart of FIG. 6, an amount of processed resources in each thread is counted first (step S601). FIG. 7 is a table that counted an amount of resources used in the process of each thread in read command units. For example, as illustrated in FIG. 7, an accumulated sum of the amount of processed resources at a certain time is two-hundred eighty nine pieces in the thread 0 and sixty four pieces in a thread 1. Accordingly, a ratio of the amount of processed resources in the respective threads is about 8:2. In step S602, the shared resources are allotted to each thread at this ratio. In so doing, as illustrated in (c) of FIG. 2, thirty-eight pieces of shared resources are allotted to the thread 0, and ten pieces of shared resources are allotted to the thread 1. By adding these to the eight pieces of fixed resources, the thread 0 becomes capable of using a total of forty six pieces of resources by 8+38=46, and the thread 1 becomes capable of using a total of eighteen pieces of resources by 8+10=18.

Accordingly, in the present embodiment, a load on each thread is determined based on a number of processed read commands, an average in a most recent certain time period of the accumulated sum of the size of the read-out data by the read command and the like. Then, larger amount of shared resources are allotted to a thread with greater load. Further, the load of each thread may be re-evaluated at a time such as after having processed a certain number of commands, or every certain time.

In the above, the shared resources are distributed by the amount of processed resources in each thread, that is, by a ratio of an used amount of a read buffer 6 used in the past in each thread, however, no limitation is made to the above method so long as being based on the used amount of a read buffer 6 used in the past in each thread.

Returning to FIG. 5 the read command is received in step S502 via a port 21. Accordingly, the process based on the read command is included in the thread 0. In step S503, an amount of resources that will be necessary in the process based on the read command is specified. For example, in assuming that a read-out size of the read command is 256 kbytes and a data size that can be read out in one resource is 4 kbytes, the resources necessary for this case becomes sixty four pieces.

Further, in step S504, a determination is made on whether there is a vacancy in the total of fourty six pieces of resources, namely the fixed resources of the thread 0 and the shared resources or not. That is, a determination is made on whether there is a region in which data being read out does not exist or not in the regions of the fixed resources or the shared resources of the thread 0 in the read buffer 6.

In a state where the data read from NAND chips 41, 42, . . . 4n to the read buffer 6 is not performed at all, since there is a vacancy in the fixed resources (step S504: Yes) due to all of the forty-eight pieces of resources that the thread 0 can use being vacant, the process proceeds to step S505. In step S505, a thread executing unit 3 performs one resource worth of data read from the NAND chips 41, 42, . . . 4n via a NAND controller 5. That is, the thread executing unit 3 causes one resource worth of read-out data from the NAND chips 41, 42, . . . 4n to be read out in the region of the fixed resource or the shared resource in the read buffer 6.

Thereafter, the process proceeds to step S506, a determination is made as to whether there is data that has not yet been read out or not, and the process ends in a case where there is no read-out data (step S506: No), however, returns to step S504 if there is data that has not yet been read out (step S506: Yes). This is repeated until the thread 0 reads out data in the forty six pieces of available resources. When the read out of the data worth forty six pieces of resources is finished, a vacancy in the available resources in the thread 0 becomes zero in step S504 (step S504: No), whereby the process proceeds to step S507, and the thread executing unit 3 suspends rest of the read-out process of the thread 0. Thereafter, the process proceeds to the read command process of the thread 1 (step S508). In the read command process of the thread 1 also, the processes similar to the above processes are executed.

According to the memory system 100 of the present embodiment, the shared resources are allotted to each thread in accordance with the ratio of the number of resources that are already processed in each thread. As illustrated in (c) of FIG. 2, according to the present embodiment, since the forty six pieces of resources become available in the thread 0, read performance is improved for fourteen pieces than in the case of (a) in FIG. 2 that fixedly allots the resources and can only use thirty two pieces in each thread. In the present embodiment also, the threads are switched by round robin. The allotment of the shared resources to each thread is re-calculated at a predetermined timing, such as after having processed a certain number of commands, or every certain time. Due to this, load of the command processing in each thread is checked, and the shared resources can suitably be distributed according to the loads of the threads.

Further, for example, in the case where the read command controller 2 received the read command that reads out 256 kbytes that is worth sixty four pieces of resources as the thread 0, and received the read command that reads out 4 kbytes that is worth one piece of resource as the thread 1, the surplus of the resources become as illustrated in FIG. 4 (c).

In the method that fixedly allots the sixty four pieces of resources to two threads by thirty two pieces each as illustrated in (a) of FIG. 4, all of the thirty two pieces as allotted are used in thread 0, whereas in the thread 1, thirty one pieces of resources become excessive since only one piece of resource is used therein. Contrary to this, when the resources are allotted as illustrated in (c) of FIG. 4 as in this embodiment, the thread 0 can use forty six pieces of resources can be used for the process of the read command of 256 kbytes, and the thread 1 uses one piece among the eight pieces as fixedly allotted thereto, and only seven pieces of resources become excessive. As above, according to the memory system 100 of the present embodiment also, it becomes possible to reduce the surplus in the resources.

According to the second embodiment, the buffer regions (resources) are allotted dynamically depending on data of the load of each thread of the past in the memory system that works on a plurality of threads. Due to this, larger number of resources can be allotted to threads with the read command with a large amount of read-out data and with large number of simultaneous issuance of read commands from a host, whereby the performance of the read command process can be improved.

### Third Embodiment

The present embodiment is another embodiment of the second embodiment. In the present embodiment, shared resources are allotted to each thread based on a queue length that measures a read-out data amount of a read command that is waiting for processing by a command queue for each thread in a read command controller 2 in predetermined units (for example, 4 kbytes that is a cluster size).

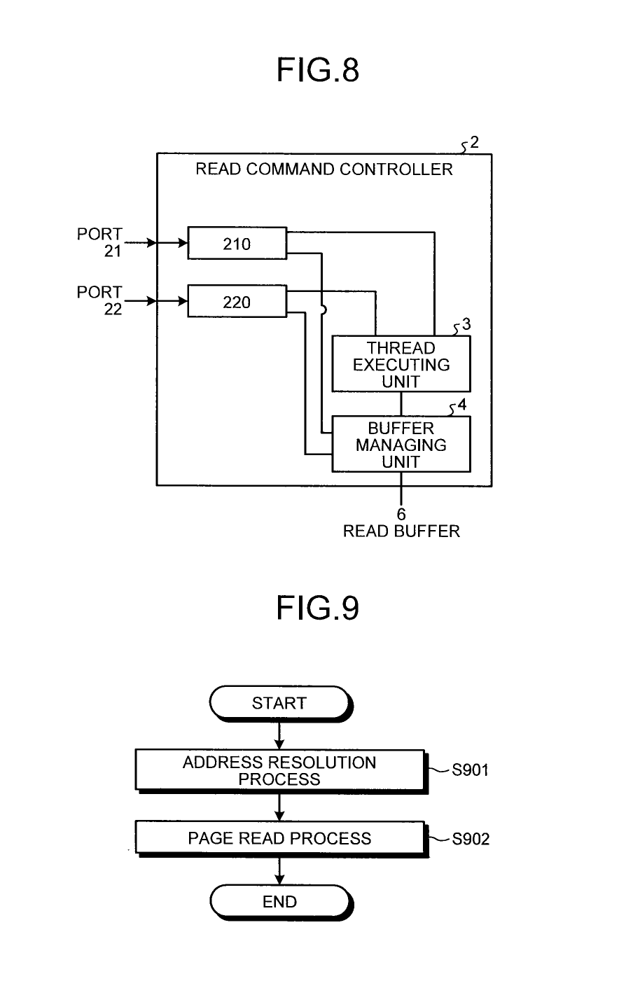

For example, as illustrated in FIG. 8, the read command controller 2 manages command queues 210 and 220 indicating data amounts that are scheduled to be read by the read commands for each thread in cluster size units. The command queue 210 corresponds to the thread 0, and the command queue 220 corresponds to the thread 1. In the present embodiment, commands from a port 21 belong to the thread 0, and commands from a port 22 belong to the thread 1, so the data amount that is scheduled to be read by the read command from the port 21 is indicated by the command queue 210, and the data amount that is scheduled to be read by the read command from the port 22 is indicated by the command queue 220.

When the thread executing unit 3 finishes processing the read command of the thread 0, the queue length of the command queue 210 decreases by the data amount read out by the read command, and when the read command of the thread 1 is finished processing, the queue length of the command queue 220 decreases by the data amount read out by the read command. A buffer managing unit 4 allots the shared resources to the threads 0 and 1 based on the queue lengths of the command queues 210 and 220, that is, the data amounts scheduled to be read out in each thread. A method of calculating allotment amounts from the queue lengths is not limited so long as larger number of shared resources are allotted to threads with longer queue length. For example, a predetermined amount of shared resources may be allotted if the queue length of a certain thread is a predetermined threshold or more.

In the present embodiment, a load of each thread is determined based on a number of read commands in an unprocessed command queue, or a total sum of a size of the data scheduled to be read out by the read command. Then, larger number of shared resources are allotted to a thread with greater load. Further, the load of each thread may be re-evaluated at a time such as after having processed a certain number of commands, or every certain time.

According to the third embodiment, the buffer regions (resources) are allotted dynamically based on the data amount scheduled to be read out in each thread in the memory system that works on a plurality of threads. Due to this, larger number of resources can be allotted to threads with the read command with a large amount of read-out data and with large number of simultaneous issuance of read commands from a host, whereby the performance of the read command process can be improved.

Notably, although a port number was set to two, a thread number was set to two, and the ports and the threads were caused to be on one-to-one basis in the first to third embodiments, a limitation is not necessarily made hereto. Further, the port number and the thread number may not be limited to two, and may be a larger number greater than two. Even if the thread number is three or more, the processes of the threads are switched by round robin. The mount of the fixed resources may be changed according to the thread number.

Further, in a case where there is only one thread, the aforementioned fixed allotment becomes unnecessary, and all of the resources can entirely be used for the thread.

### Fourth Embodiment

In the present embodiment, in a case where resources that are available for a certain thread has been used up and the process has shifted to processing of another thread in the first to third embodiments, read out to a page register (page read) is performed for rest of data of a suspended read process.

Specifically, process of FIG. 9 is performed when a rest of a read process of a thread 0 needs to be suspended (step S310 of FIG. 3, and step S507 of FIG. 5) in a case where there no longer is a vacancy in shared resources in FIG. 3 (FIG. 3, step S306: No), or in a case where there no longer is a vacancy in resources in FIG. 5 (FIG. 5, step S504: No).

In step S901 of FIG. 9, an address resolution process is performed for all or part of data that is to be a target of the remaining read process of the read command that was suspended. That is, corresponding physical addresses of NAND chips 41, 42, . . . 4n are calculated from logical addresses designated by a host. Next, in step S902, a page read process is executed on the NAND chips 41, 42, . . . 4n based on the physical addresses obtained in step S901. That is, the read process is executed from memory cell arrays of the NAND chips 41, 42, . . . 4n to page registers provided respectively in the NAND chips 41, 42, . . . 4n.

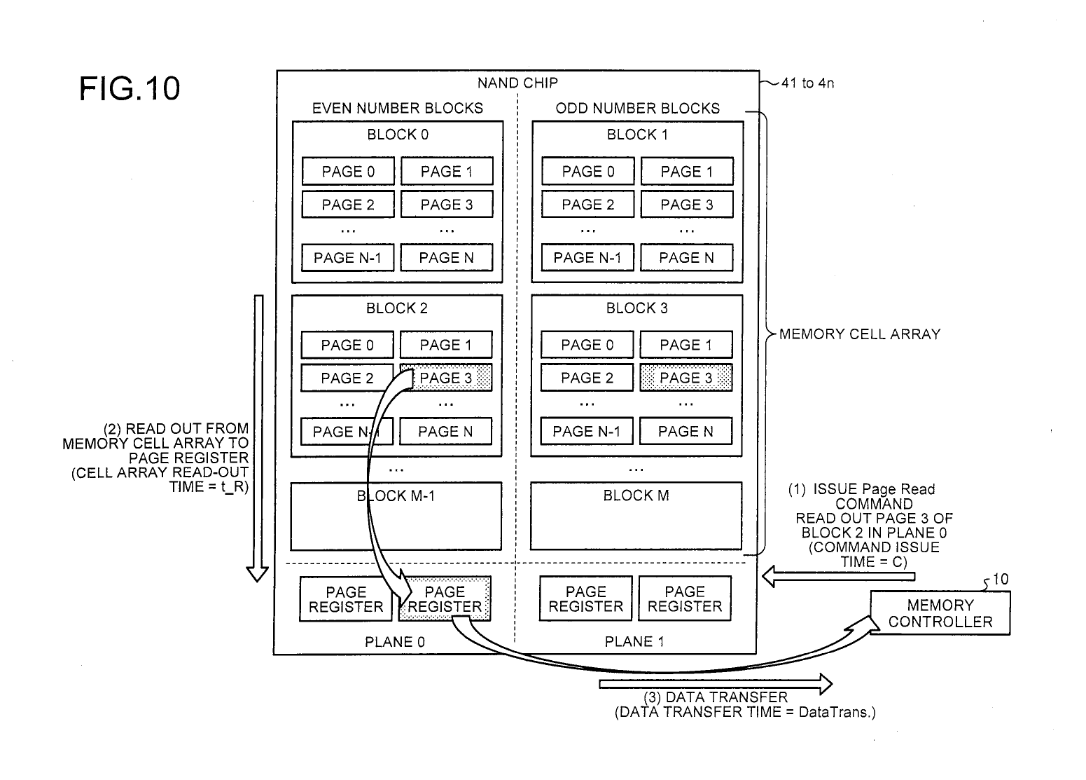

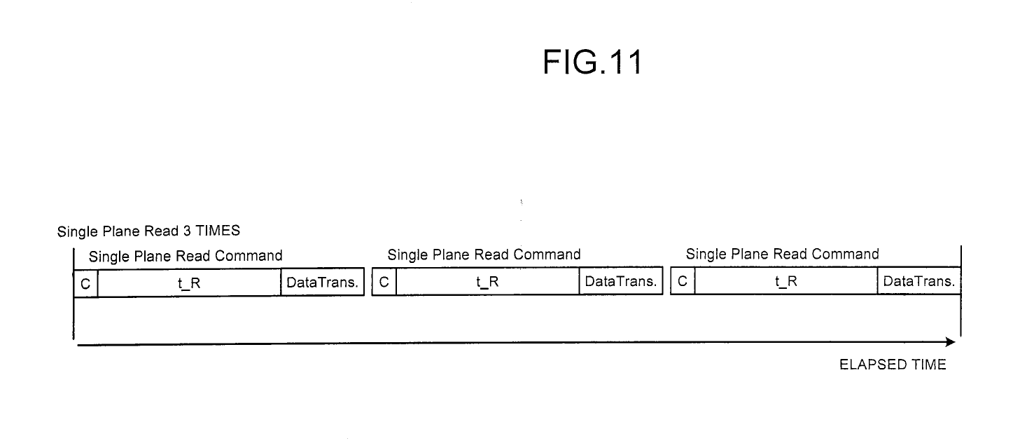

As illustrated in FIG. 10 and FIG. 11, time t_R that is required for the page read that is a read out from the memory cell arrays to the page registers of the NAND chips 41, 42, . . . 4n is long, namely about 60 μs. A data transfer process thereafter is a transfer process from the page registers to a read buffer 6 of a memory controller 10, which takes about 20 μs for every 4 kbytes. So long as securing of regions in the read buffer 6 for the read out, that is, of the resources is performed by the time of starting the data transfer process from the page registers, such is not necessary in a read out process on the page registers. Accordingly, next, the processes switch by round robin to the thread of which read out process was suspended, whereby the time required for execution process of the read command can be shortened since the process to transfer from the page registers to cluster buffers (not illustrated) in a NAND controller 5 and the data transfer process to the read buffer 6 simply need to be performed when there is a vacancy in the available resources in step S305 of FIG. 3 and step S504 of FIG. 5, due to the read out of the read-out data is completed to the page registers. Notably, in a case where the process ended without suspending the process in the thread, the above page read is not necessary.

According to the fourth embodiment, in a case where the available resources are used up in a certain thread and the process proceeded to the processing of another thread, the page read is performed for the rest of the data in the suspended read process. Due to this, an improvement in reading performance becomes possible.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory controller that reads data from nonvolatile memory, the memory controller comprising:
first and second ports that receive commands from outside the memory controller;
a thread executing unit that executes a first thread that is a set of processes based on the command received by the first port, and a second thread that is a set of processes based on the command received by the second port;
a buffer that stores the data read out from the nonvolatile memory; and
a buffer managing unit that manages a first buffer area that is a region of the buffer to be allotted to the first thread and a second buffer area that is a region of the buffer to be allotted to the second thread, wherein
the thread executing unit stores read data that is read out from the nonvolatile memory in the first buffer area upon executing a process based on a first read command included in the first thread, and stores read data that is read out from the nonvolatile memory in the second buffer area upon executing a process based on a second read command included in the second thread, and
the buffer managing unit dynamically allots regions in the buffer to the first buffer area and the second buffer area.

2. The memory controller according to claim 1, wherein
the buffer managing unit is configured to be capable of allotting a first fixed capacity of the regions of the buffer to the first thread, and allotting a second fixed capacity of the regions of the buffer to the second thread, and further, capable of dynamically allotting a first variable capacity of shared regions in the regions of the buffer to the first thread, and dynamically allotting a second variable capacity of the shared regions in the regions of the buffer to the second thread.

3. The memory controller according to claim 2, wherein
the buffer managing unit specifies a capacity of the buffer necessary for data read-out by the first read command, is capable of allotting a capacity exceeding the first fixed capacity from the shared regions as the first variable capacity, specifies a capacity of the buffer necessary for data read-out by the second read command, and is capable of allotting a capacity exceeding the second fixed capacity from the shared regions as the second variable capacity.

4. The memory controller according to claim 2, wherein
the buffer managing unit is capable of allotting the first variable capacity and the second variable capacity from the shared regions based on a first used amount of the buffer that was used in past by the first thread, and a second used amount of the buffer that was used in the past by the second thread.

5. The memory controller according to claim 2, wherein
the buffer managing unit is capable of allotting the first variable capacity and the second variable capacity from the shared regions based on a data amount scheduled to be read out by an unprocessed read command included in the first thread, and a data amount scheduled to be read out by an unprocessed read command included in the second thread.

6. The memory controller according to claim 1, wherein
the thread executing unit
suspends a process of the first thread when data is read out to all regions of the first buffer area in a case where a data amount scheduled to be read out by the first read command exceeds a capacity of the first buffer area in the process of the first thread, and
suspends a process of the second thread when data is read out to all regions of the second buffer area in a case where a data amount scheduled to be read out by the second read command exceeds a capacity of the second buffer area in the process of the second thread.

7. The memory controller according to claim 6, wherein
data that has not yet been read out to the first buffer area among data scheduled to be read out by the first read command is read out to a page register from a memory cell array of the nonvolatile memory after having suspended the process of the first thread, and
data that has not yet been read out to the second buffer area among data scheduled to be read out by the second read command is read out to a page register from a memory cell array of the nonvolatile memory after having suspended the process of the second thread.

8. The memory controller according to claim 1, further comprising:
three or more ports.

9. The memory controller according to claim 1, wherein
the thread executing unit executes three or more threads, and
the buffer managing unit is capable of allotting the regions of the buffer to each of the threads.

10. The memory controller according to claim 1, wherein
the thread executing unit executes a plurality of the threads by round robin.

11. A memory system comprising:
nonvolatile memory;
first and second ports that receive commands from outside the memory controller;
a thread executing unit that executes a first thread that is a set of processes based on the command received by the first port, and a second thread that is a set of processes based on the command received by the second port;
a buffer that stores the data read out from the nonvolatile memory; and
a buffer managing unit that manages a first buffer area that is a region of the buffer to be allotted to the first thread and a second buffer area that is a region of the buffer to be allotted to the second thread, wherein
the thread executing unit stores read data that is read out from the nonvolatile memory in the first buffer area upon executing a process based on a first read command included in the first thread, and stores read data that is read out from the nonvolatile memory in the second buffer area upon executing a process based on a second read command included in the second thread, and
the buffer managing unit dynamically allots regions in the buffer to the first buffer area and the second buffer area.

12. The memory system according to claim 11, wherein
the buffer managing unit is configured to be capable of allotting a first fixed capacity of the regions of the buffer to the first thread, and allotting a second fixed capacity of the regions of the buffer to the second thread, and further, capable of dynamically allotting a first variable capacity of shared regions in the regions of the buffer to the first thread, and dynamically allotting a second variable capacity of the shared regions in the regions of the buffer to the second thread.

13. The memory system according to claim 12, wherein
the buffer managing unit specifies a capacity of the buffer necessary for data read-out by the first read command, is capable of allotting a capacity exceeding the first fixed capacity from the shared regions as the first variable capacity, specifies a capacity of the buffer necessary for data read-out by the second read command, and is capable of allotting a capacity exceeding the second fixed capacity from the shared regions as the second variable capacity.

14. The memory system according to claim 12, wherein
the buffer managing unit is capable of allotting the first variable capacity and the second variable capacity from the shared regions based on a first used amount of the buffer that was used in past by the first thread, and a second used amount of the buffer that was used in the past by the second thread.

15. The memory system according to claim 12, wherein
the buffer managing unit is capable of allotting the first variable capacity and the second variable capacity from the shared regions based on a data amount scheduled to be read out by an unprocessed read command included in the first thread, and a data amount scheduled to be read out by an unprocessed read command included in the second thread.

16. The memory system according to claim 11, wherein
the thread executing unit:
suspends a process of the first thread when data is read out to all regions of the first buffer area in a case where a data amount scheduled to be read out by the first read command exceeds a capacity of the first buffer area in the process of the first thread, and
suspends a process of the second thread when data is read out to all regions of the second buffer area in a case where a data amount scheduled to be read out by the second read command exceeds a capacity of the second buffer area in the process of the second thread.

17. The memory system according to claim 16, wherein
data that has not yet been read out to the first buffer area among data scheduled to be read out by the first read command is read out to a page register from a memory cell array of the nonvolatile memory after having suspended the process of the first thread, and
data that has not yet been read out to the second buffer area among data scheduled to be read out by the second read command is read out to a page register from a memory cell array of the nonvolatile memory after having suspended the process of the second thread.

18. The memory system according to claim 11, further comprising:
three or more ports.

19. The memory system according to claim 11, wherein
the thread executing unit executes three or more threads, and
the buffer managing unit is capable of allotting the regions of the buffer to each of the threads.

20. The memory system according to claim 11, wherein
the thread executing unit executes a plurality of the threads by round robin.
